(19) United States
(12) Patent Application Publication
(10) Pub. No.: US 2013/0058655 A1
(43) Pub. Date: Mar. 7, 2013

(54) TRANSMISSION APPARATUS FOR OPTICAL TRANSPORT NETWORK, AND STAFF CONTROL METHOD THEREFOR

(71) Applicant: Fujitsu Limited, Kawasaki-shi (JP)

(72) Inventors: Toshiaki Okubo, Kawasaki (JP); Toru Katagiri, Kawasaki (JP); Hiroyuki Honma, Kawasaki (JP)

(73) Assignee: FUJITSU LIMITED, Kawasaki-shi (JP)

(21) Appl. No.: 13/666,398

(22) Filed: Nov. 1, 2012

Related U.S. Application Data
(63) Continuation of application No. PCT/JP2010/058909, filed on May 26, 2010.

(51) Int. Cl. H04J 14/00

(52) U.S. Cl. 398/66

(57) ABSTRACT

A transmission apparatus for an optical transport network includes maps client data to a payload of an optical transport unit in order to obtain a higher layer frame generated based on a clock on the optical transport network side, and sends the higher layer frame to the optical transport network. A Cn value indicating an amount of the client data to be mapped to the payload of the optical transport unit is computed based on a counted value, counted using a clock of the client data, of a time period corresponding to the payload of the optical transport unit in the higher layer frame generated using a clock of the optical transport network.

### CROSS-REFERENCE TO RELATED APPLICATION

This application is a continuation application of International Application No. PCT/JP2010/058909 filed on May 26, 2010 and designated the U.S., the entire contents of which are incorporated herein by reference.

### FIELD

The embodiments discussed herein are related to a transmission apparatus for an optical transport network, and to a stuff control method therefor.

### BACKGROUND

Recently, the OTN (Optical Transport Network), standardized according to the ITU-T Recommendations G.709 and employing the WDN (Wave Division Multiplexing) that may cope with the rapidly increasing Internet traffic, is quickly being introduced to commercial systems as a platform capable of making the so-called transparent transmission. The transparent transmission does not require a higher layer to be aware of a lower layer when making an end-to-end communication of a client signal in not only synchronous networks such as the SONET (Synchronous Optical Network) and the SDH (Synchronous Digital Hierarchy), but also in asynchronous networks such as the IP (Internet Protocol) network and the ETHERNET (registered trademark) network.

Mapping methods for mapping various client data to the payload of the OPUk (Optical channel Payload Unit) in an OTN transmission apparatus are standardized as the BMP (Bit-synchronous Mapping Procedure), the AMP (Asynchronous Mapping Procedure), and the GMP (Generic Mapping Procedure).

One stuff control method of the GMP determines a Cn value computing method using Sigma-Delta based justification distribution (hereinafter referred to as the “Sigma-Delta distribution method”), and the data inserting position and the stuff byte inserting position within the payload are determined from the computed Cn value. Cn generally refers to the stuff controlling method in units of n bits, and C8 and C16 respectively represent the stuff controlling method in units of 1 byte and 2 bytes, respectively. The stuff control method described above is being standardized according to the ITU-T Recommendations G.709/Y.1331.

The BMP maps specific data to the payload area of a higher layer frame. The BMP performs the transfer by increasing the transfer rate and adding the necessary overhead, and is used for the mapping in the OPUk>=ODUk (Optical channel Data Unit)>=OTUk (Optical channel Transport Unit) system. The BMP is mainly used for the mapping of synchronous data, and does not perform the stuff control.

The AMP is fully asynchronous, and maps specific data having a relatively close bit ate to the payload area of the higher layer frame. The AMP increases the transfer rate and adds the necessary overhead, maps the stuff control bit to the overhead part, and maps the stuff bytes to the payload area, in order to make the transfer by performing the stuff control at a fixed position. The AMP is a mapping method that is provided to mainly transfer SONET/SDH signals according to the OTN transmission system.

On the other hand, the GMP is a mapping method that maps signals having bit rates not transferable by the BMP or the AMP, and is fully asynchronous and does take the bit rate into consideration. The GMP increases the transfer rate, add the necessary overhead, and maps the effective number of bytes within the payload to the overhead part. In addition, the effective data and the stuff bytes are distributed uniformly and arranged in the payload, and the effective data and the stuff bytes within the payload are identified depending on the number of effective bytes within the overhead. The GMP is a mapping method that is provided to mainly map ETHERNET (registered trademark, hereinafter simply referred to as the “LAN”) signals, such as the GbE/100 GbE signals. The GMP is not a fixed stuff control method, but is a variable stuff control method that requires new techniques.

There is a known technique that uses a selection table to allocate synchronization data within synchronizing frames when multiplexing asynchronous data within the synchronizing frames for the communication between nodes, and performing the multiplexing and demultiplexing at the transmitting and receiving nodes by referring to the table (for example, Japanese Laid-Open Patent Publication No. 9-191310).

As described above, the BMP of the conventional OTN transmission apparatus performs no stuff control, and the AMP of the conventional OTN transmission apparatus performs the fixed stuff control. However, because the Sigma-Delta distribution method of the GMP performs the variable stuff control, the stuff byte position needs to be easily extractable. Bytes of the asynchronous data and the stuff bytes are inserted into a predetermined region according to the Sigma-Delta distribution method, and the stuff byte positions are uniformly distributed within the predetermined region according to the Sigma-Delta distribution method.

A description will be given of a method of computing the C8 value, that is the number of bytes of the client data that may be mapped in the payload of OPU0, in a case in which the predetermined region is formed by the payload part of the frame of OPU0. In the following formula (1), fc denotes the bit rate of the client data, fp denotes the bit rate of the payload of OPU0, and 15232 is the number of bytes of the payload of OPU0.

C8.nominal=fc/fp×15232 (1)

The “C8.nominal” indicating the number of bytes of the client data (GIGABIT ETHERNET (registered trademark) data) that may be mapped to the payload of OPU0 when the clock variation is 0% becomes as follows, where “ 15/16” indicates a coefficient for mapping the client data to the GFP-T frame, and “238/239×1244160” indicates the bit rate of the payload of OPU0.

$$\begin{matrix}C 8. nominal = ( 15 / 16 \times 1250000 ) / ( 238 / 239 \times 1244160 ) \times 15232 \\ = 14407.311\end{matrix}$$

A judgement is made to determine whether the client data is to be mapped to the payload area of OPU0 or the stuff bytes, that is, dummy data, are to be mapped to the payload area of OPU0, depending on a computation result obtained by computing the following relationship (2), after computing the Cn value (C8 value in case of stuff control in units of bytes).

m×C8 mod 15232<C8 (2)

In the relationship (2) above, m denotes the byte position (1 byte to 15232 bytes) of the payload part of OPU0. The client data is mapped to the byte position m when the relationship (2) stands (or is true), and the stuff byte is mapped to the byte position m when the relationship (2) does not stand (or is false).

Hence, the bit rate of the client and the bit rate of the payload of the OPU0 frame need to be computed at each byte position of the OPU0 payload. However, it may be difficult to compute the Cn value at a high speed using small-scale hardware. In addition, in order to judge whether the relationship (2) is satisfied, the stuff byte position where the stuff byte is mapped needs to be determined in real-time, however, such a real-time determination of the stuff byte position may be difficult.

### SUMMARY

Accordingly, it is an object in one aspect of the embodiment to provide a transmission apparatus for an optical transport network, and a stuff control method therefor, that may compute the Cn value at a high speed using small-scale hardware.

According to one aspect of the embodiment, a transmission apparatus for an optical transport network may include a mapping unit configured to map client data to a payload of an optical transport unit in order to obtain a higher layer frame generated based on a clock on the optical transport network side; and an interface unit configured to send the higher layer frame to the optical transport network, wherein the mapping unit includes a Cn computing unit configured to compute a Cn value indicating an amount of the client data to be mapped to the payload of the optical transport unit, based on a counted value, counted using a clock of the client data, of a time period corresponding to the payload of the optical transport unit in the higher layer frame generated using a clock of the optical transport network, and wherein information of the Cn value computed by the Cn computing unit is mapped to an overhead of the optical transport unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a frame structure of an OTN frame in one embodiment;

FIG. 2 is a diagram illustrating an example of a structure of an OPU0 frame;

FIG. 3 is a diagram illustrating an example of coding patterns of C1-C14, II, and DI bits;

FIG. 4 is a diagram illustrating examples of a C8 value when mapping a client signal to OPU0;

FIG. 5 is a block diagram illustrating an example of a structure of an OTN transmission apparatus in one embodiment;

FIG. 6 is a block diagram illustrating an example of a structure of an ODU mapper in a first embodiment;

FIGS. 7A through 7E are diagrams illustrating an example of a relationship between a higher layer frame and an ODU0 frame;

FIG. 8 is a diagram illustrating an example of a stuff position table in one embodiment;

FIG. 9 is a diagram for explaining the C8 value inserted in an overhead of the ODU0 frame;

FIG. 10 is a block diagram illustrating an example of a structure of an ODU demapper in one embodiment;

FIG. 11 is a diagram illustrating a stuff procedure of the OPU0 in one embodiment;

FIG. 12 is a flow chart for explaining a C8 calculating process in one embodiment;

FIG. 13 is a flow chart for explaining a mapping process in one embodiment;

FIG. 14 is a block diagram illustrating an example of a structure of the ODU mapper in a second embodiment;

FIG. 15 is a block diagram illustrating an example of the structure of the ODU mapper in a third embodiment;

FIG. 16 is a diagram for explaining a write address and a read address of a memory;

FIGS. 17A through 17C are diagrams for explaining an operation of a memory monitoring circuit;

FIG. 18 is a block diagram illustrating an example of a structure of a C8 computing unit in a first embodiment;

FIG. 19 is a block diagram illustrating an example of the structure of the C8 computing unit in a second embodiment;

FIG. 20 is a block diagram illustrating an example of the structure of the C8 computing unit in a third embodiment; and

FIGS. 21A through 21D are diagrams for explaining a distributing process of a CPU.

### DESCRIPTION OF EMBODIMENTS

Preferred embodiments of the present invention will be described with reference to the accompanying drawings.

A description will now be given of a transmission apparatus for an optical transport network, and to a stuff control method therefor, in each embodiment according to the present invention.

<Structure of OTN Frame>

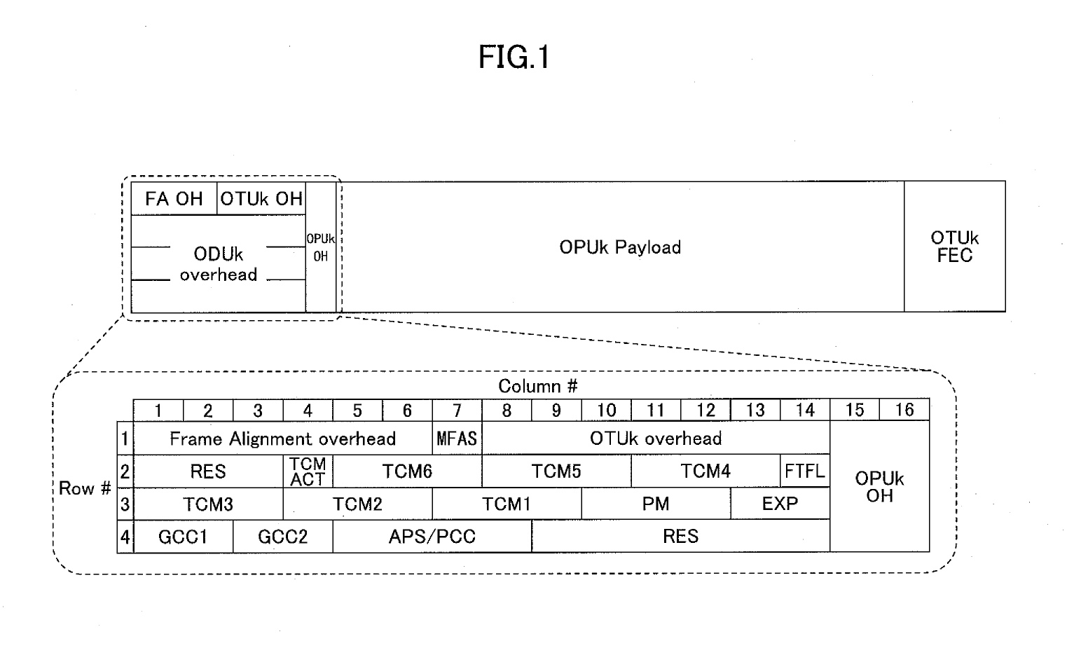

First, a description will be given of a structure of an OTN frame that first accommodates a client signal. FIG. 1 is a diagram illustrating an example of a frame structure of the OTN frame in one embodiment. The OTN frame includes an overhead part, an OPUk (Optical channel Payload Unit, where k is 0 or a positive integer) payload part, and an OTUkFEC (Optical channel Transport Unit k Forward Error Correction) part. The OPU is an example of an optical transport unit.

The overhead part has first (1st) through sixteenth (16th) columns that are used to manage the connection and the quality, where each column has a size of 16 bytes×4 rows. The OPUk payload part has seventeenth (17th) through 3824th columns that accommodate a client signal for providing one more services, where each column has a size of 3808 bytes×4 rows. The OTUkFEC part has 3825th through 4080 columns that are used to correct an error generated during the transmission, where each column has a size of 256 bytes×4 rows.

An ODUk (Optical channel Data Unit) part refers to the OPUk payload part added with the overhead byte (OH) that is used to manage the connection and the quality. An OTUk refers to the ODUk part added with the overhead byte that is used to manage the frame synchronization, the connection, and the quality, and the OTUkFEC overhead part.

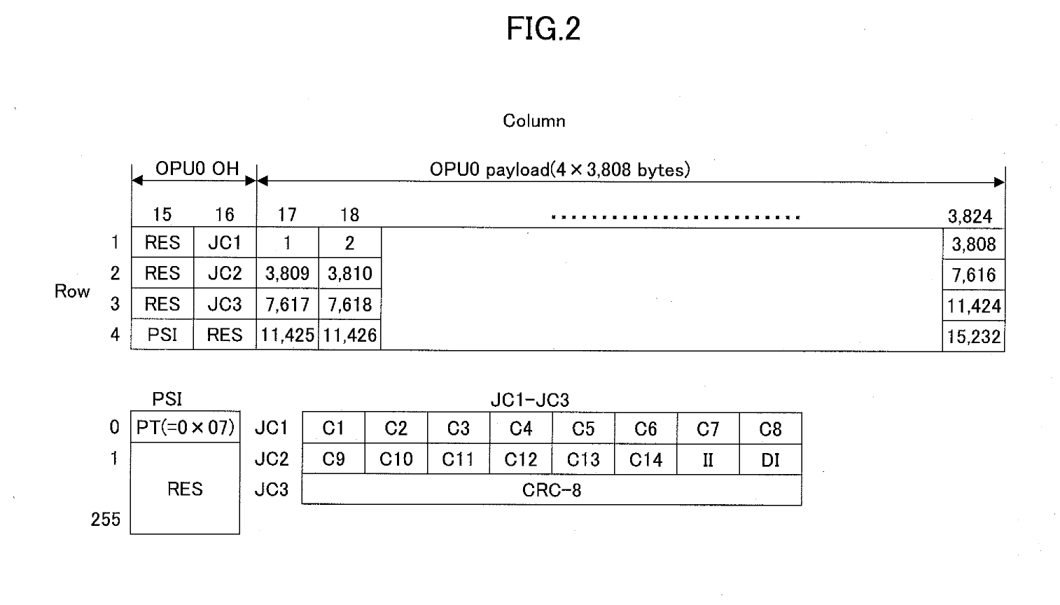

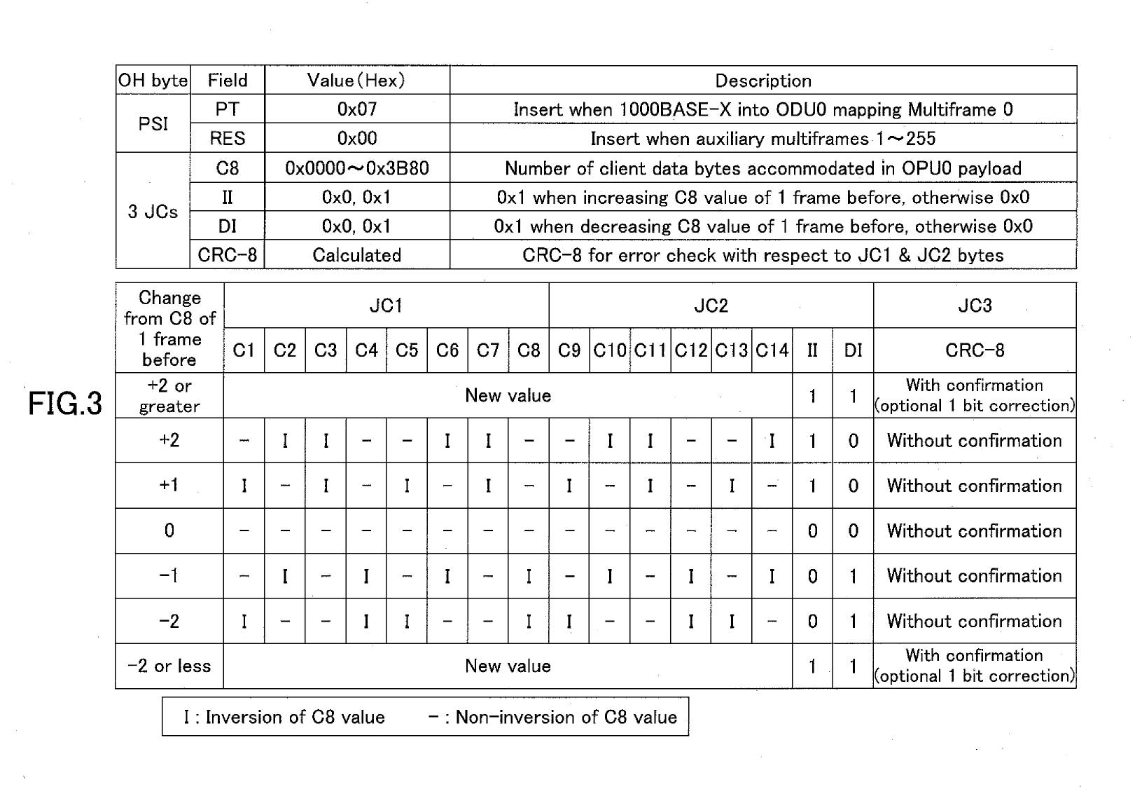

FIG. 2 is a diagram illustrating an example of a structure of an OPU0 frame. FIG. 3 is a diagram illustrating the overhead provisions of the OPU0 and coding patterns of JC1 through JC3. In FIG. 2, bytes of PS1, JC1, JC2, and JC3 are provided in the overhead (OPU0 OH) of the OPU0. In FIG. 2, RES denotes reserved bytes 0x00 (0x indicates a hexadecimal representation). A value 0x07 is set to the PSI byte in the case of a multi-frame 0.

The C8 value is represented by C1-C14 bits within the JC2 byte. In addition, an increase or a decrease of the C8 value is instructed by an II (Increment Indicator) bit or a DI (Decrement Indicator) bit within the JC2 byte.

Coding patterns of the C1 through C14 (C1-C14), II, and DI bits are as illustrated in FIG. 3. In the coding patterns, “-” indicates a bit non-inversion, and “I” indicates a bit inversion. For example, when the C8 value is “C8.nominal” and there is no increase or decrease in value, the C8 value according to the coding patterns illustrated in FIG. 3 becomes “14407”. In addition, a CRC-8 check byte with respect to the JC1 and JC2 bytes is set in the JC3 byte.

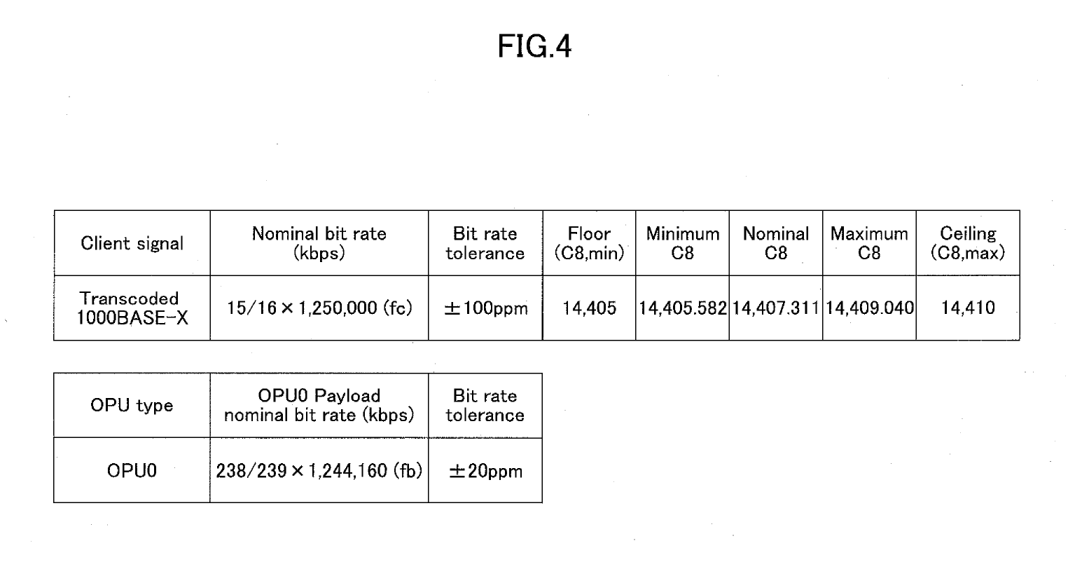

FIG. 4 is a diagram illustrating examples of a lower limit value (14405), a minimum value (14405.582), a normal value (14407.311), a maximum value (14409.040), and an upper limit value (14410) of the C8 value when mapping the client signal (1000BASE-X) to the OPU0. In this case, a tolerable error of the transmission rate of the client signal is ±100 ppm, and a tolerable error of the transmission rate of the OPU0 is ±20 ppm.

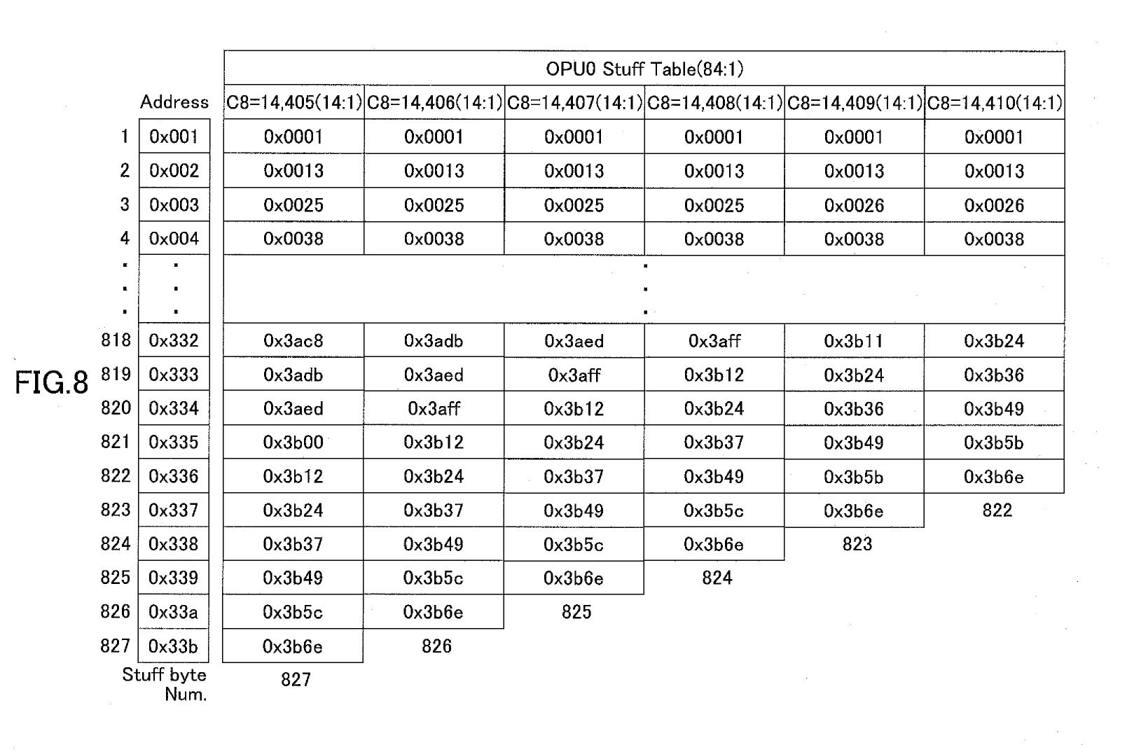

From FIG. 4, the C8 value takes a value greater than or equal to 14405 and less than or equal to 14410. In this embodiment, a stuff position table 55 illustrated in FIG. 8 is created in advance based on the relationship (2) described above, for each of the C8 values of “14405”, “14406”, “14407”, “14408”, “14409”, and “14410”.

<Structure of OTN Transmission Apparatus>

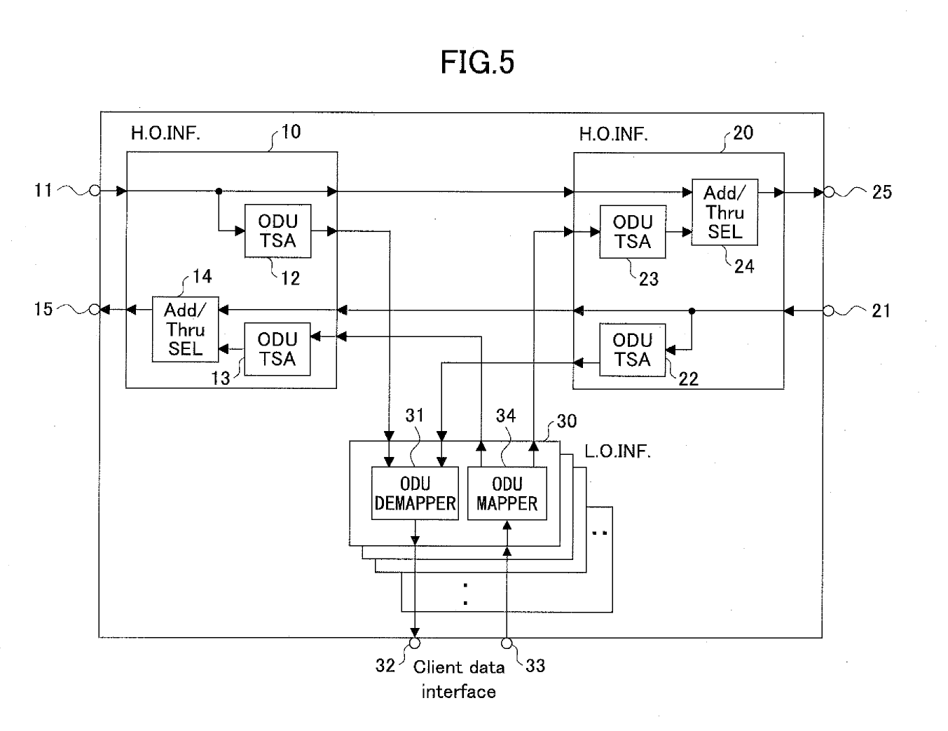

FIG. 5 is a block diagram illustrating an example of a structure of an OTN transmission apparatus in one embodiment. The OTN transmission apparatus illustrated in FIG. 5 is formed by an OTN-ADM (Add Drop Multiplexer). In FIG. 5, a higher layer frame signal, that is obtained by converting a higher frame layer optical signal on an optical transfer network side received from one optical channel into an electrical signal, is input to a terminal 11. The higher layer frame signal is supplied to a selector (Add/Thru_SEL) 24 within a high-speed signal interface unit 20 via a high-speed signal interface unit (H. O. INF) 10. An extracting part (ODU TSA) 12 within the high-speed signal interface unit 10 extracts required ODU time slots from the higher layer frame signal, and supplies the ODU time slots to an ODU demapper 31 via a cross connect part (not illustrated) within a low-speed signal interface unit (L. O. INF) 30.

Similarly, a higher layer frame signal, that is obtained by converting a higher frame layer optical signal received from another optical channel into an electrical signal, is input to a terminal 21. The higher layer frame signal is supplied to a selector (Add/Thru_SEL) 14 within a high-speed signal interface unit 10 via a high-speed signal interface unit (H. O. INF) 20. An extracting part (ODU TSA) 22 within the high-speed signal interface unit 20 extracts required ODU time slots from the higher layer frame signal, and supplies the ODU time slots to the ODU demapper 31 via a cross connect part (not illustrated) within the low-speed signal interface unit (L. O. INF) 30.

The ODU demapper 31 within the low-speed signal interface unit 30 obtains client data by demapping the ODU frames supplied thereto. The client data are mapped to the client signal in a client signal mapper (not illustrated) within the low-speed signal interface unit 30 and output from a terminal 32.

In addition, the client signal supplied to a terminal 33 is demapped by a client signal demapper (not illustrated) within the low-speed signal interface unit 30. Client data obtained by the demapping in the client signal demapper are mapped to the ODU frames in an ODU mapper 34, and supplied to an inserting part (ODU TSA) 13 or 23 of the high-speed signal interface unit 10 or 20, via the crossconnect part (not illustrated).

The ODU frames, whose timing is matched to that of the higher layer frame signal in the inserting part 13 of the high-speed signal interface unit 10, are supplied to the selector 14 in which the ODU frames are inserted into predetermined ODU time slots of the higher layer frame signal. The higher layer frame signal output from the selector 14 is output from a terminal 15, and sent to the one optical channel by being converted into a higher layer frame optical signal.

The ODU frames, whose timing is matched to that of the higher layer frame signal in the inserting part 23 of the high-speed signal interface unit 20, are supplied to the selector 24 in which the ODU frames are inserted into predetermined ODU time slots of the higher layer frame signal. The higher layer frame signal output from the selector 24 is output from a terminal 25, and sent to the other optical channel by being converted into a higher layer frame optical signal.

<Structure of ODU Mapper>

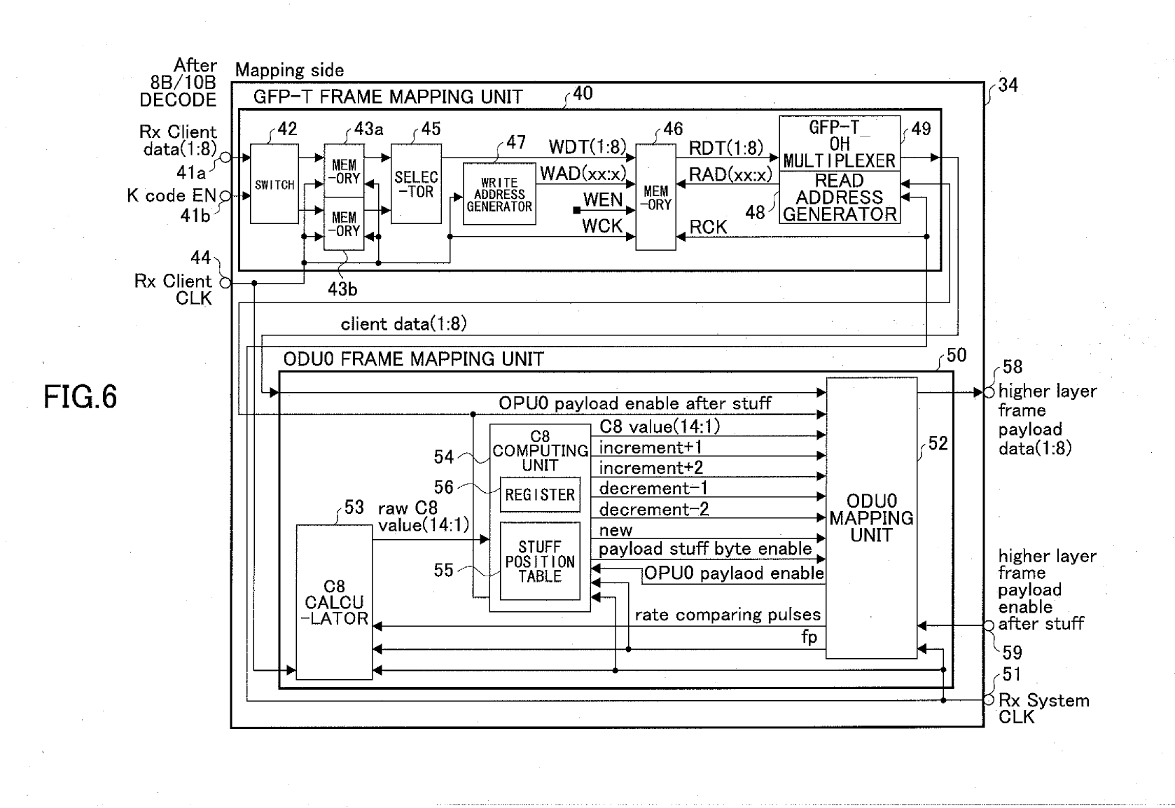

FIG. 6 is a block diagram illustrating an example of a structure of the ODU mapper 34 in a first embodiment. The client data and a special code enable signal are supplied to terminals 41a and 31b, respectively. The client data are supplied to memories 43a and 43b via a switch 42 of a GFP (Generic Framing Procedure)-T frame mapping unit 40. Normal data and a special code of the client data are written into the memories 43a and 43b in response to a client clock supplied from a terminal 44. The client clock is synchronized to the client data.

The client data are read from the memories 43a and 43b with the order changed, and supplied to a memory 46 via a selector 45. In this example, the normal data and the special code of the client data are written into the memories 43a and 43b separately, and the reading order from the memories 43a and 43b is controlled, in order to generate super blocks.

A write address generator 47 receives the client clock, and generates a write address that is supplied to the memory 46. Hence, the client data are written into the memory 46. On the other hand, a read address generator 48 receives a system clock on the higher layer frame side from a terminal 51, and an OPU0 payload enable after stuff signal from a C8 computing unit 54, and generates a read address that is supplied to the memory 46.

Accordingly, the memory 46 may be used to convert the client data synchronized to the client clock into the client data synchronized to the system clock. The client data synchronized to the system clock and read from the memory 46 are formed into GFP-T frames by being multiplexed with a GFP-T overhead in a GFP-T OH multiplexer 49. The GFP-T frames are supplied to an ODU0 mapping unit 52 of a ODU− frame mapping unit 50.

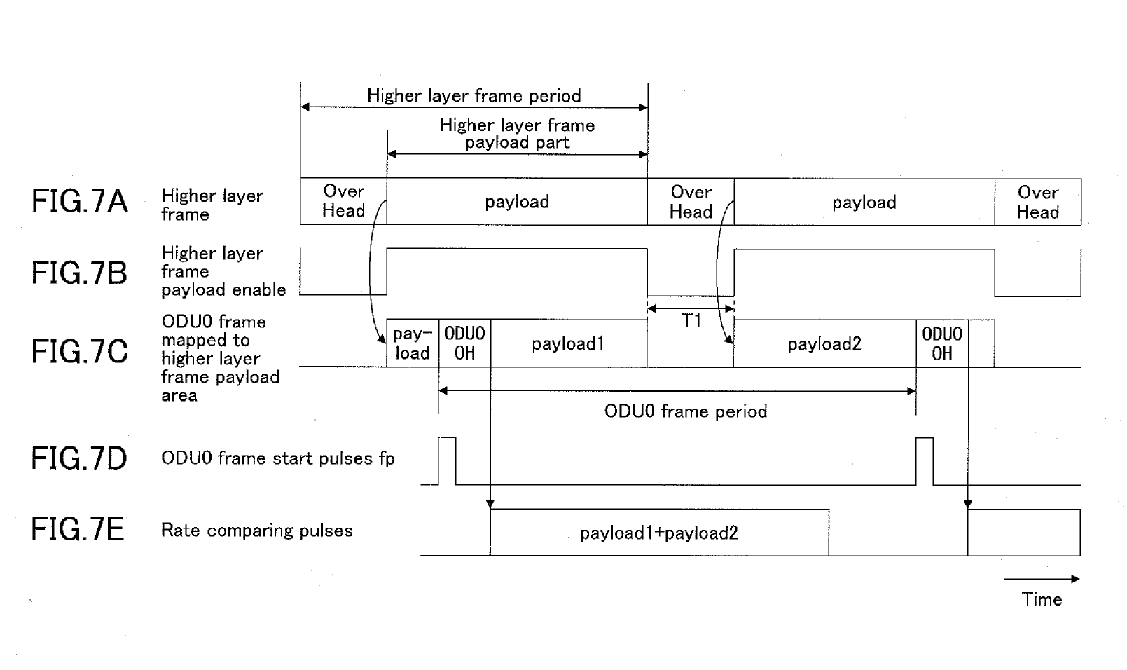

FIGS. 7A through 7E is a diagram illustrating an example of a relationship between the higher layer frame and the ODU0 frame. The higher layer frame illustrated in FIG. 7A and the ODU0 frame illustrated in FIG. 7C are not synchronized to each other. The ODU0 frame is mapped to the payload area of the higher layer frame. In this state, a time interval T1 corresponding to the overhead of the higher layer frame is removed from the payload area of the ODU0 frame, as illustrated in FIG. 7C. For this reason, the period of the ODU0 frame varies depending on the overhead position of the higher layer frame.

In this embodiment, the ODU0 mapping unit 52 generates OPU0 frame start pulses fp illustrated in FIG. 7D and rate comparing pulses illustrated in FIG. 7E. The OPU0 frame start pulse fp assumes a high level for a predetermined time at the overhead position of the ODU0 frame. The rate comparing pulse assumes a high level only for a fixed length corresponding to the payload area of the OPU0 frame, excluding the overhead area of the higher layer frame, between the OPU0 frame start pulses fp.

A C8 calculator 53 of the ODU0 frame mapping unit 50 counts the high-level periods of the rate comparing pulses supplied from the ODU0 mapping unit 52, using the client clock. The C8 calculator 53 latches the counted value by the OPU0 frame start pulse fp supplied from the ODU0 mapping unit 52, and calculates the C8 value from the counted value according to the following formula, indicating the number of bytes of the client data mappable during the high-level period of the rate comparing pulses.

(C8 Value)=(Counted Value of Rate Comparing Pulses)×{(System Clock)/(Client Clock)}

The C8 value obtained as a result from the above described calculation is monitored k consecutive times in an increment direction or in a decrement direction, and a correction is performed in the same increment or decrement direction when the C8 value is incremented or decremented k consecutive times. The value of k may be determined by taking into consideration a maximum frequency deviation and a minimum frequency deviation of the client clock and the system clock. The C8 calculator 53 supplies the C8 value that is calculated to the C8 computing unit 54, and initializes the counted value.

The C8 computing unit 54 compares the C8 value received from the C8 calculator 53 and the C8 value that is sent in the previous frame and retained in a register 56, in order to generate each stuff information. The C8 computing unit 54 includes the stuff position table 55 illustrated in FIG. 8.

The byte positions where the stuff bytes are to be inserted are registered in advance in the stuff position table 55 illustrated in FIG. 8 for each of the C8 values 08=14405, 14406, 14407, 14408, 14409, and 14410. For example, in a case in which C8=14405, 827 bytes of the stuff bytes are respectively inserted at the byte numbers 0x0001, 0x0013, . . . , and 0x03b6e (0x indicates a hexadecimal representation). Similarly, 825 bytes of the stuff bytes are inserted in a case in which C8=14407, and 822 bytes of the stuff bytes are inserted in a case in which C8=14410.

The C8 computing unit 54 refers to the stuff position table 55 using the C8 value that is sent in the previous frame and retained in the register 56 within the C8 computing unit 54, in order to select a column and find the stuff byte positions where the stuff bytes are to be mapped. In addition, the C8 computing unit 54 generates a payload stuff byte enable signal that assumes a low level at the stuff byte position, and supplies the payload stuff byte enable signal to the ODU0 mapping unit 52. Further, the C8 computing unit 54 generates, based on the comparison result of the received C8 value and the 08 value sent in the previous frame, a 14-bit C8 value (C8 value to be set that is received from the C8 calculator 53) and the II and DI bits to be set in the JC1 and JC2 bytes, and stuff information indicating a 1-byte increase or a 2-byte increase from the previous frame, a 1-byte decrease or a 2-byte decrease from the previous frame, a new value, and the like. The 14-bit C8 value and the II and DI bits, and the stuff information generated from the C8 computing unit 54 are supplied to the ODU0 mapping unit 52.

In addition, the C8 computing unit 54 generates the OPU0 payload enable after stuff signal that assumes a high level to instruct the OPU0 payload part, and assumes a low level at the stuff byte position. The OPU0 payload enable after stuff signal is supplied to the GFP-T frame mapping unit 40 and the ODU0 mapping unit 52.

The ODU0 mapping unit 52 receives a higher layer frame payload enable after stuff signal illustrated in FIG. 7B from a terminal 59, and uses the higher layer frame payload enable after stuff signal as a reference in order to generate an OPU0 payload enable signal, the OPU0 frame start pulses fp, and the rate comparing pulses. The OPU0 payload enable signal and the OPU0 frame start pulses fp are supplied to the C8 computing unit 54, and the OPU0 frame start pulses fp and the rate comparing pulses are supplied to the C8 calculator 53. The ODU0 mapping unit 52 allocates the data of the GFP-T frames (when the OPU0 payload enable after stuff signal has the high level) supplied from the GFP-T frame mapping unit 40, and stuff bytes (when the OPU0 payload enable after stuff signal has the low level), in accordance with the OPU0 payload enable after stuff signal, and further maps the OPU0 overhead (including JC1 through JC3) and the ODU0 overhead, in order to output the higher layer frame payload data from a terminal 58.

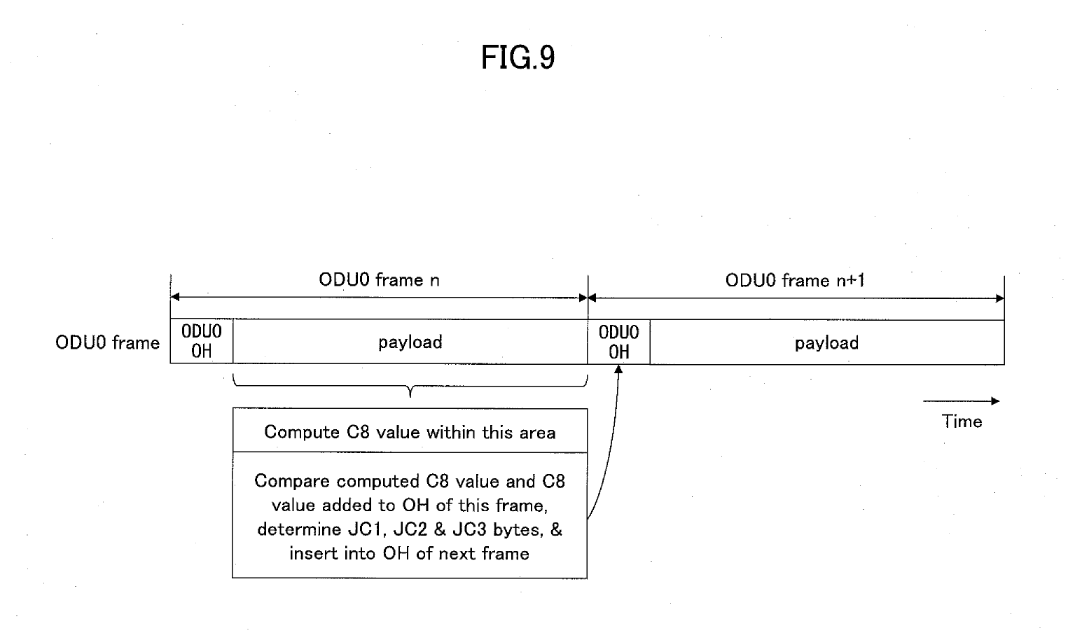

As illustrated in FIG. 9, the C8 value inserted into the JC1 and JC2 bytes of the overhead of the ODU0 frame n is the value calculated from the counted value of the rate comparing pulses of the previous frame n-1. In addition, the C8 value currently calculated from the counted value of the rate comparing pulses of the current frame n and the C8 value previously calculated from the counted value of the rate comparing pulses of the previous frame n-1 are compared, in order to determine the JC1, JC2, and JC3 bytes including the currently calculated C8 value and insert the JC1, JC2, and JC3 bytes into the OPU0 overhead of the frame n+1.

<Structure of ODU Demapper>

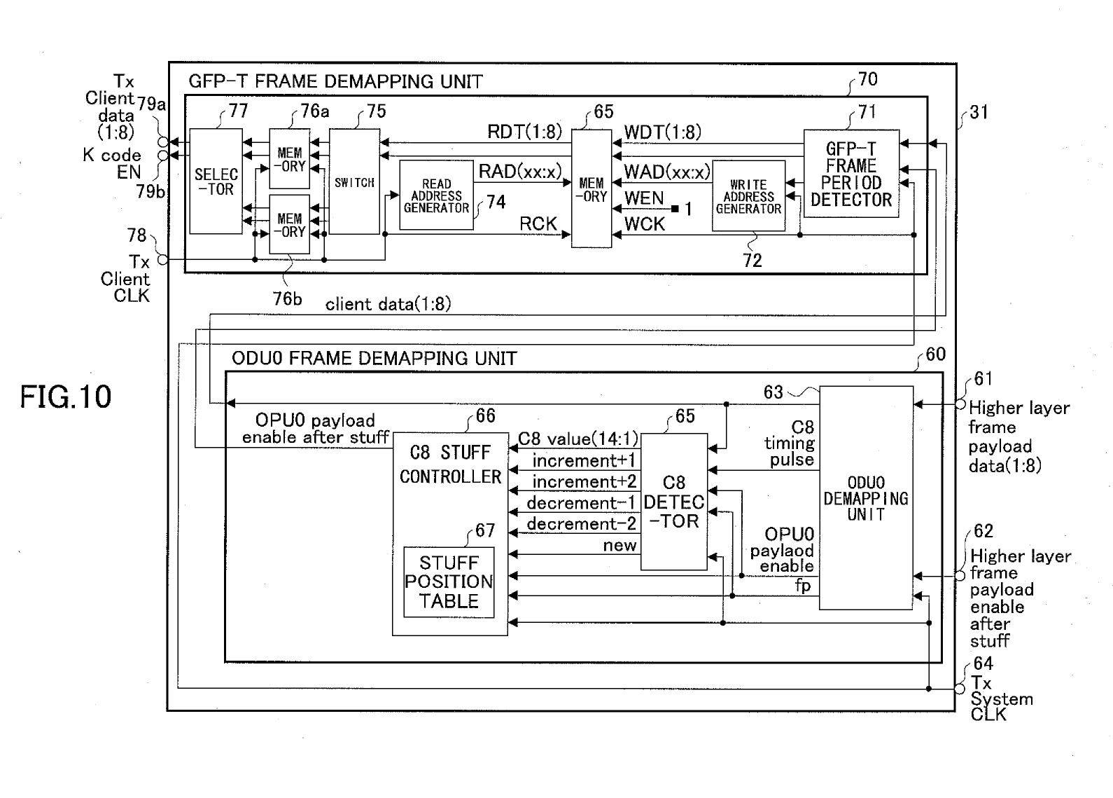

FIG. 10 is a block diagram illustrating an example of a structure of the ODU demapper 31 in one embodiment. The higher layer frame payload data and the higher layer frame payload enable after stuff signal are input from terminals 61 and 62, respectively, and supplied to an ODU0 demapping unit 63 of an ODU0 frame demapping unit 60. In addition, the system clock is input to a terminal 64. The ODU0 demapping unit 63 demaps the ODU0 frames to output the GFP-T frames, and also generates C8 timing pulses, the OPU0 payload enable signal, and the OPU0 frame start pulses fp.

A C8 detector 65 extracts the C8 value from the GFP-T frames by using the C8 timing pulses, and compares the extracted C8 value and the C8 value received in the previous frame. Based on this comparison of C8 values, the C8 detector 65 generates and supplies to a C8 stuff controller 66 a 14-bit C8 value (the number of bytes of the client data included in the current OPU0 frame) and the stuff information indicating the 1-byte increase or the 2-byte increase from the previous frame, the 1-byte decrease or the 2-byte decrease from the previous frame, the new value (new), the payload stuff byte enable signal that assumes the low level at the stuff byte position, and the like.

The C8 stuff controller 66 includes a stuff position table 67 which may be the same as the stuff position table 55 illustrated in FIG. 8, and refer to the stuff position table 67 by the C8 value (the number of bytes of the client data included in the current OPU0 frame) in order to find the stuff byte position. In addition, the C8 stuff controller 66 generates and supplies to a GFP-T frame demapping unit 70 the OPU0 payload enable after stuff signal for invalidating the stuff bytes inserted into the OPU0 payload part.

A GFP-T frame synchronous detector 71 of the GFP-T frame demapping unit 70 receives the GFP-T frames from the ODU0 demapping unit 63 and the OPU0 payload enable after stuff signal from the C8 stuff controller 66. The GFP-T frame synchronous detector 71 performs a synchronous detection of the GFP-T frames and synchronizes the GFP-T frames, generates the special code enable signal, and supplies the special code enable signal to a memory 73. In addition, a write address generator 72 receives the system clock from a terminal 64, generates a write address, and supplies the write address to the memory 73. Hence, the client data from the payload of the GFP-T frames are written into the memory 73. On the other hand, a read address generator 74 receives the client clock from a terminal 78, generates a read address, and supplies the read address to the memory 73. Hence, the client data are read from the memory 73 in synchronism with the client clock.

The client data from the memory 73 are supplied to memories 76a and 76b via a switch 75. The normal data and the special code of the client data are written into the memories 76a and 76b separately, in response to the client clock received from the terminal 78, in order to disassemble the super block. The data read from the memories 76a and 76b in response to the client clock are output from a terminal 78a via a selector 77. The special code enable signal is output from a terminal 79b.

<Stuff Procedure of OPU0>

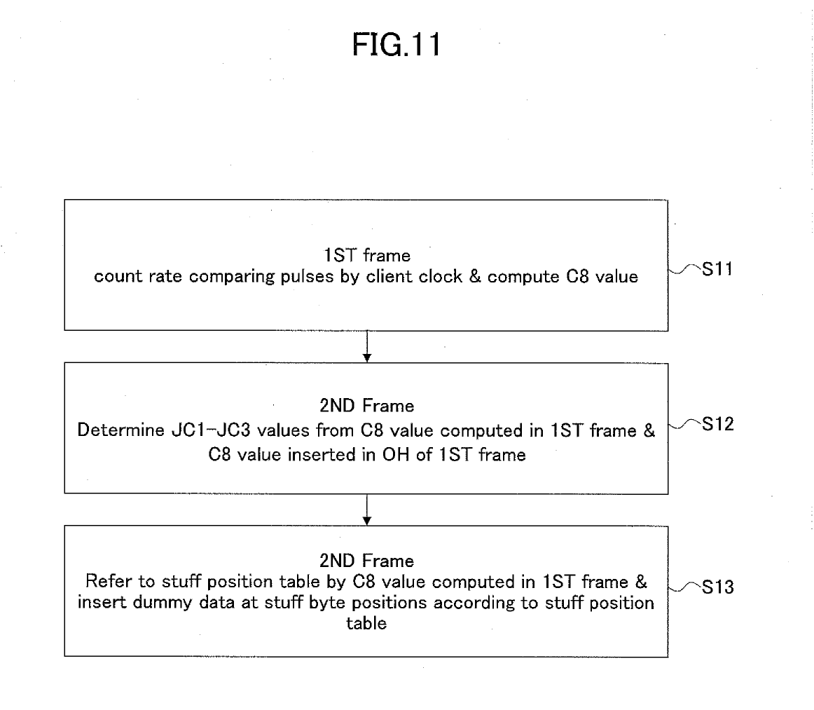

FIG. 11 is a diagram illustrating a stuff procedure of the OPU0 in one embodiment. In FIG. 11, in the first frame, the C8 calculator 53 counts the high-level periods of the rate comparing pulses using the client clock, and calculates the C8 value from the counted value (step S11).

In the second frame, the C8 computing unit 54 determines each of the JC1, JC2, and JC3 bytes from the C8 value calculated in the first frame and the C8 value inserted into the overhead of the first frame (step S12). The JC1, JC2, and JC3 bytes determined in this step S12 are inserted into the overhead of the third frame.

Further, in the second frame, the C8 computing unit 54 refers to the stuff position table 55 using the C8 value calculated in the first frame in order to obtain the stuff byte positions by selecting the column in the stuff position table 55, and generates the payload stuff byte enable signal that assumes the low level at the stuff byte positions. The ODU0 mapping unit 52 inserts the dummy data at the stuff byte positions based on the payload stuff byte enable signal (step S13).

<C8 Calculating Process>

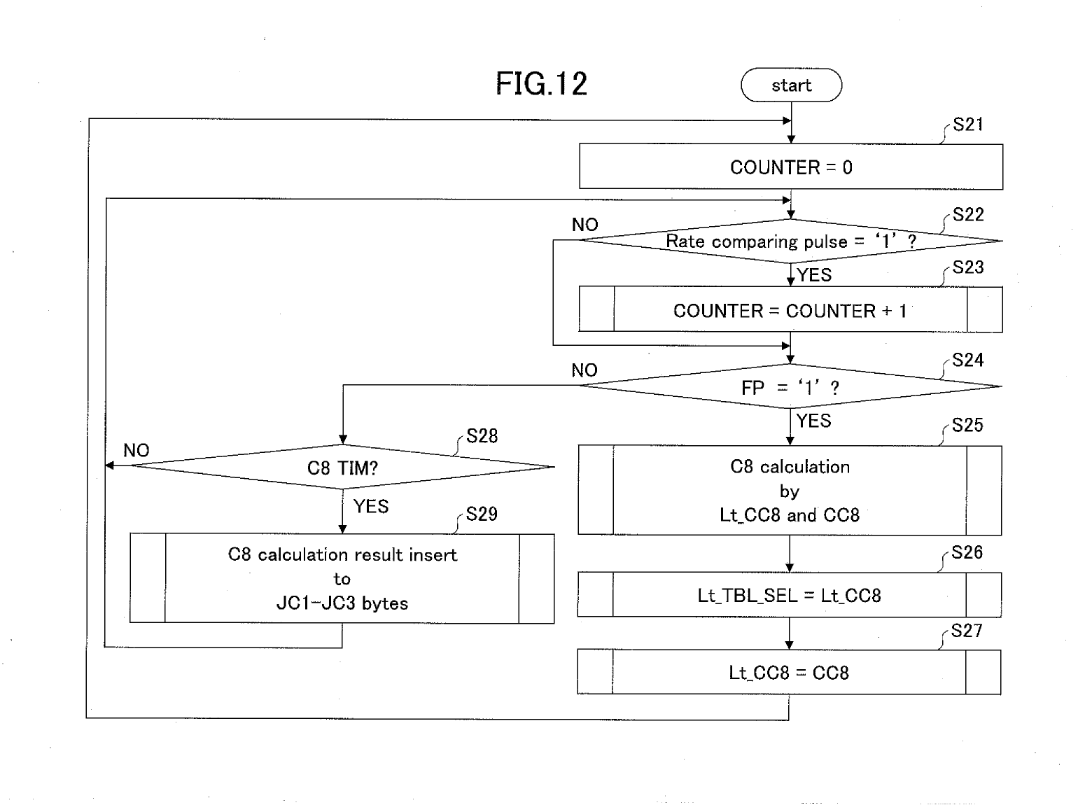

FIG. 12 is a flow chart for explaining a C8 calculating process in one embodiment. In a step S21 in FIG. 12, the C8 calculator 53 resets the counter value to 0. Then, a step S22 judges whether the rate comparing pulse has the high level (“1”), and the process advances to a step S23 when the judgement result in the step S22 is YES. In the step S23, the C8 calculator 53 increments the counter value by 1.

Next, a step S24 judges whether the OPU0 frame start pulse fp has the high level (“1”) and the position is the start of the OPU0 frame, and the process advances to a step S25 when the judgement result in the step S24 is YES. In the step S25, the C8 calculator 53 calculates the C8 value (CC8) from the counter value, and supplies the C8 value to the C8 computing unit 54. In addition, the C8 computing unit 54 compares the C8 value (CC8) received from the C8 calculator 53 and the C8 value (Lt_CC8) sent in the previous frame, and generates the 14-bit C8 value, the II and DI bits, and the CRC-8 to be set in the JC1, JC2, and JC3 bytes.

In a step S26, the C8 computing unit 54 sets the C8 value (Lt_CC8) sent in the previous frame as the value (latch table selection value: Lt_TBL_SEL) to be used when referring to the stuff position table 55. Thereafter, in a step S27, the C8 computing unit 54 sets the C8 value (CC8) received from the C8 calculator 53 as the C8 value (Lt_CC8) set in the previous frame, and the process returns to the step S21.

On the other hand, when the position is not the start of the OPU0 frame and the judgement result in the step S24 is NO, the process advances to a step S28. In the step S28, the ODU0 mapping unit 52 judges whether the timing is the C8 timing of the OPU0 overhead, and the process advances to a step S29 when the judgement result in the step S28 is YES. In the step S29, the ODU0 mapping unit 52 inserts the 14-bit C8 value, the II and DI bits, and the CRC-8 that are computed in the step S25 into the JC1, JC2, and JC3 bytes. The process returns to the step S22 after the step S29 or when the judgement result in the step S27 is NO.

<Mapping Process>

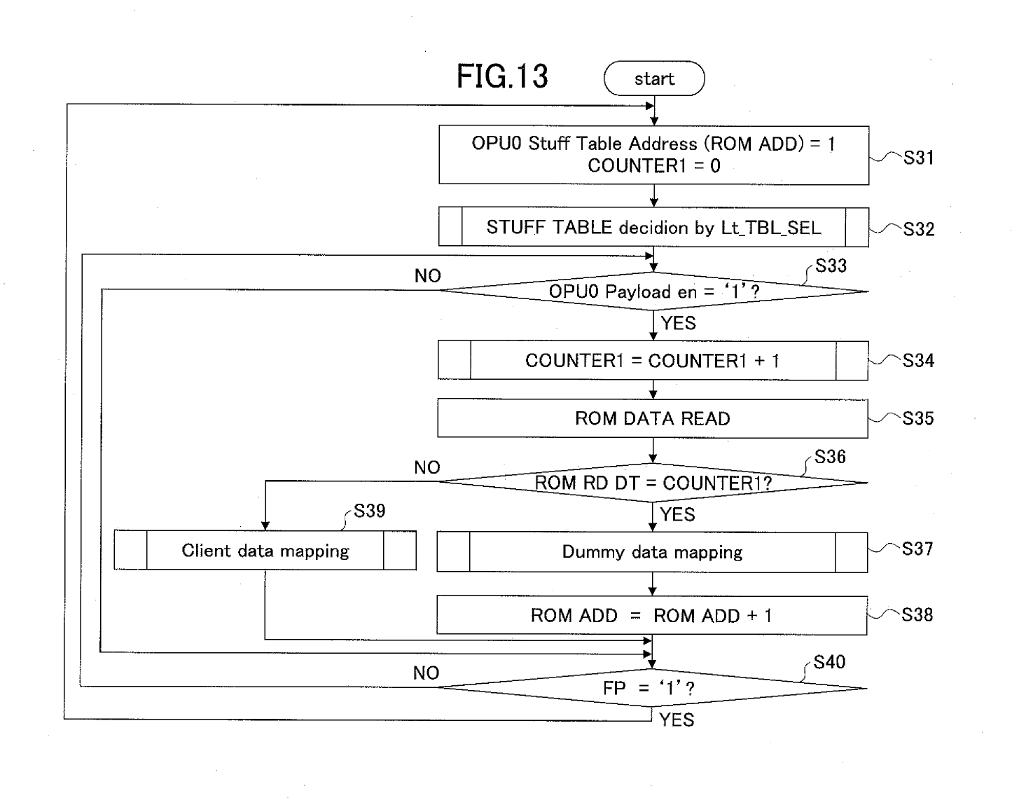

FIG. 13 is a flow chart for explaining a mapping process in one embodiment. In a step S31 in FIG. 13, the C8 computing unit 54 sets the address (ROM_ADD) of the stuff position table 55 illustrated in FIGS. 8 to 1, and resets a counter 1 that counts the OPU0 payload enable signal in units of bytes to 0. A step S32 selects the column of the stuff position table 55 that is to be referred based on the latch table selection value.

Next, in a step S33, the C8 computing unit 54 judges whether the ODU0 payload enable signal received from the ODU0 mapping unit 52 has the high level (“1”), and the process advances to a step S40 when the ODU0 payload enable signal has the low level (“0”) and the judgement result in the step S33 is NO. On the other hand, the process advances to a step S34 when the ODU0 payload enable signal has the high level and the judgement result in the step S33 is YES. In the step S34, the C8 computing unit 54 increments the counter 1 by 1. In a step S35, the C8 computing unit 54 reads the data from the selected column of the stuff position table 55 based on the address (ROM_ADD).

Next, a step S36 judges whether the value of the counter 1 matches the data (ROM RD DT) read from the stuff position table 55. When the value of the counter 1 and the data (ROM RD DT) read from the stuff position table 55 match and the judgement result in the step S36 is YES, the process advances to a step S37. In the step S37, the ODU0 mapping unit 52 maps the dummy data to the byte position instructed by the value of the counter 1 (the payload enable after stuff signal has the low level). The address (ROM_ADD) is incremented by 1 in a step S38.

On the other hand, when the judgement result in the step S36 is NO, the process advances to a step S39. In the step S39, the ODU0 mapping unit 52 maps the client data to the byte position instructed by the value of the counter 1 (the payload enable after stuff signal has the high level). The process advances to the step S40 after the step S38 or S39. The step S40 judges whether the OPU0 frame start pulse fp has the high level (“1”) and the position is the start of the OPU0 frame. The process returns to the step S31 when the judgement result in the step S40 is YES, and the process returns to the step S33 when the judgement result in the step S40 is NO.

In the embodiment described above, the C8 calculator 53 calculates the C8 value from the counted value that is obtained by counting the high-level periods of the rate comparing pulses supplied from the ODU0 mapping unit 52 using the client clock. For this reason, the calculation of the Cn value may be realized using small-scale hardware. In addition, by providing in the C8 computing unit 54 the stuff position table 55 that is obtained by calculating in advance the stuff positions for each of 6 values for the C8 value, the stuff position may be determined in real-time.

<Second Embodiment of ODU Mapper>

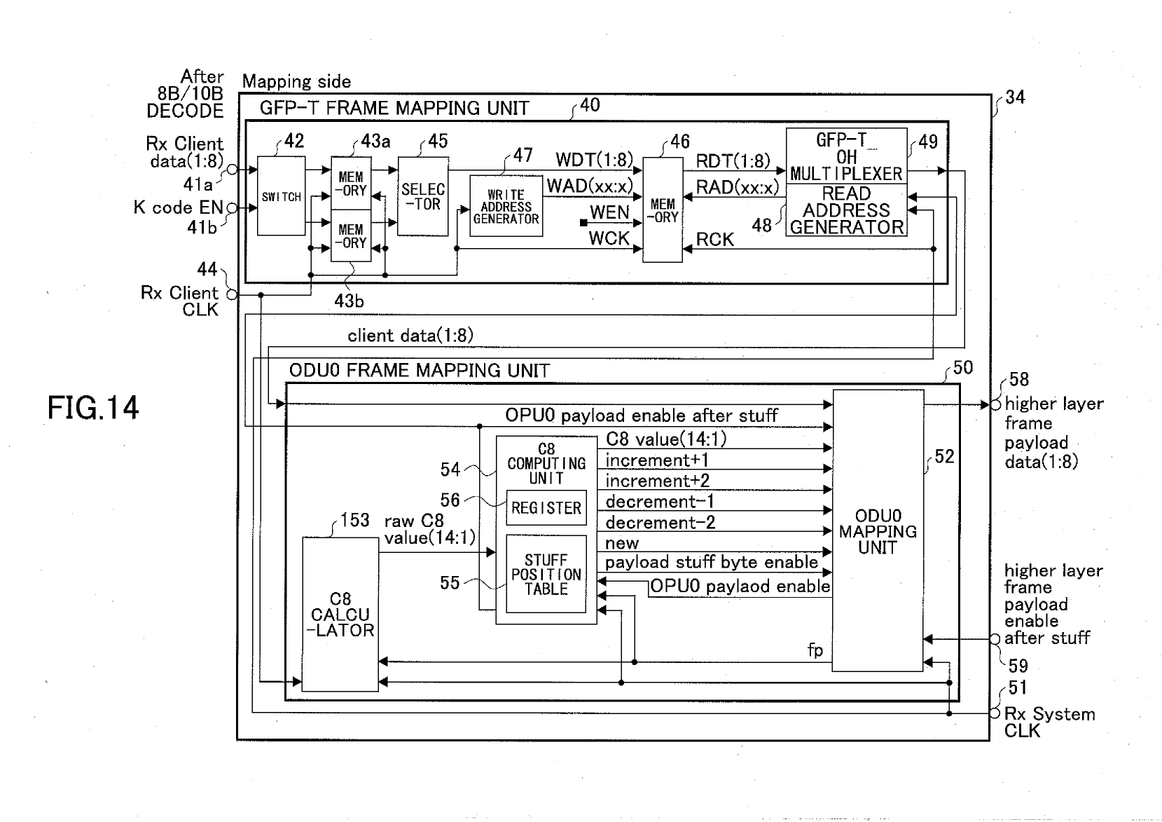

FIG. 14 is a block diagram illustrating an example of a structure of the ODU mapper 34 in a second embodiment. In this second embodiment, a C8 calculator 153 is used in place of the C8 calculator 53 of the first embodiment. Otherwise, the structure of the second embodiment is the same as that of the first embodiment.

The C8 calculator 153 receives the OPU0 frame start pulses fp illustrated in FIG. 7D from the ODU0 mapping unit 52, and counts the period of the OPU0 frame start pulses fp using the client clock. The C8 calculator 153 latches the counted value by the OPU0 frame start pulse fp, and calculates a provisional C8 value from the counted value according to the following formula, indicating the number of bytes of the client data mappable to the ODU0 frame included in the higher layer frames.

(Provisional C8 Value)=(Counted Value of Period of fp)×((System Clock)/(Client Clock)}

The calculated provisional C8 value is compared with a maximum value and a minimum value of a C8 effective range, and an excess value outside the effective range is retained. The C8 value may be determined by adding the excess value when the excess value is a positive value, and by subtracting the excess value when the excess value is a negative value, with respect to the provisional C8 value that is calculated the next time.

The C8 value that is determined is successively monitored k times in the increment direction or the decrement direction, and the correction is performed in the same increment or decrement direction when the C8 value is incremented or decremented k consecutive times. The value of k may be determined by taking into consideration a maximum frequency deviation and a minimum frequency deviation of the client clock and the system clock. The C8 calculator 153 supplies the C8 value that is calculated to the C8 computing unit 54, and initializes the counted value.

<Third Embodiment of ODU Mapper>

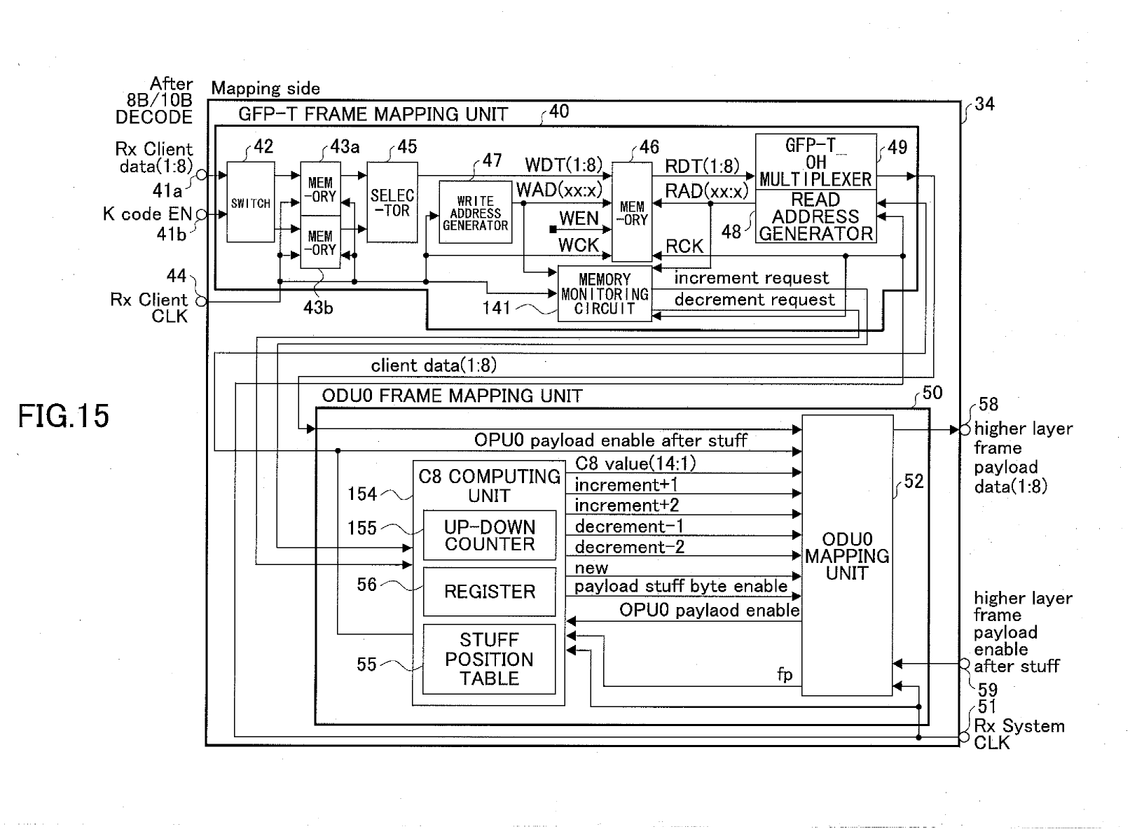

FIG. 15 is a block diagram illustrating an example of the structure of the ODU mapper 34 in a third embodiment. In this third embodiment, a memory monitoring circuit 141 is provided in the GFP-T frame mapping unit 40, the C8 calculator 53 of the ODU0 frame mapping unit 50 is omitted, and an increment request and a decrement request output from the memory monitoring circuit 141 are supplied to a C8 computing unit 154 within the ODU0 frame mapping unit 50. Otherwise, the structure of the third embodiment is the same as that of the first embodiment. The memory monitoring circuit 141 receives the client clock from the terminal 44 and the write address generated from the write address generator 47, and also receives the system clock on the higher layer frame side from the terminal 51 and the read address generated from the read address generator 48.

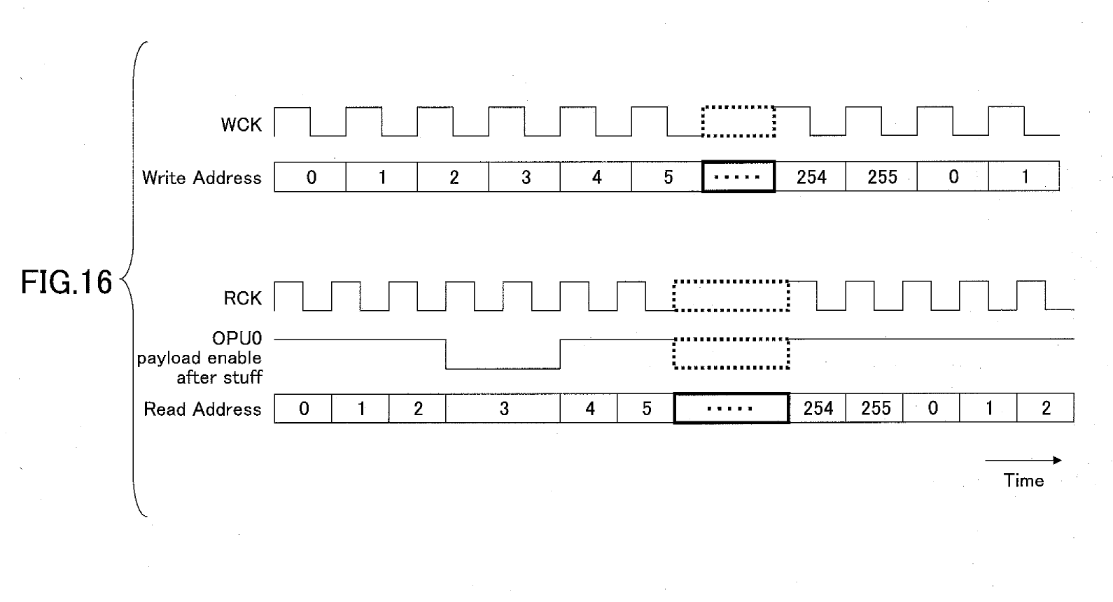

In a case in which the memory 46 has the addresses 0 through 256, for example, the write address generator 47 generates the write address by counting up the client clock WCK as illustrated in FIG. 16. In addition, the read address generator 48 generates the read address by counting up the system clock RCK as illustrated in FIG. 16. The read address generator 48 stops the counting up the system clock RCK during the low-level period of the OPU0 payload enable after stuff signal indicating the stuff byte position, and the read address extends while the counting of the system clock RCK is stopped as illustrated in FIG. 16.

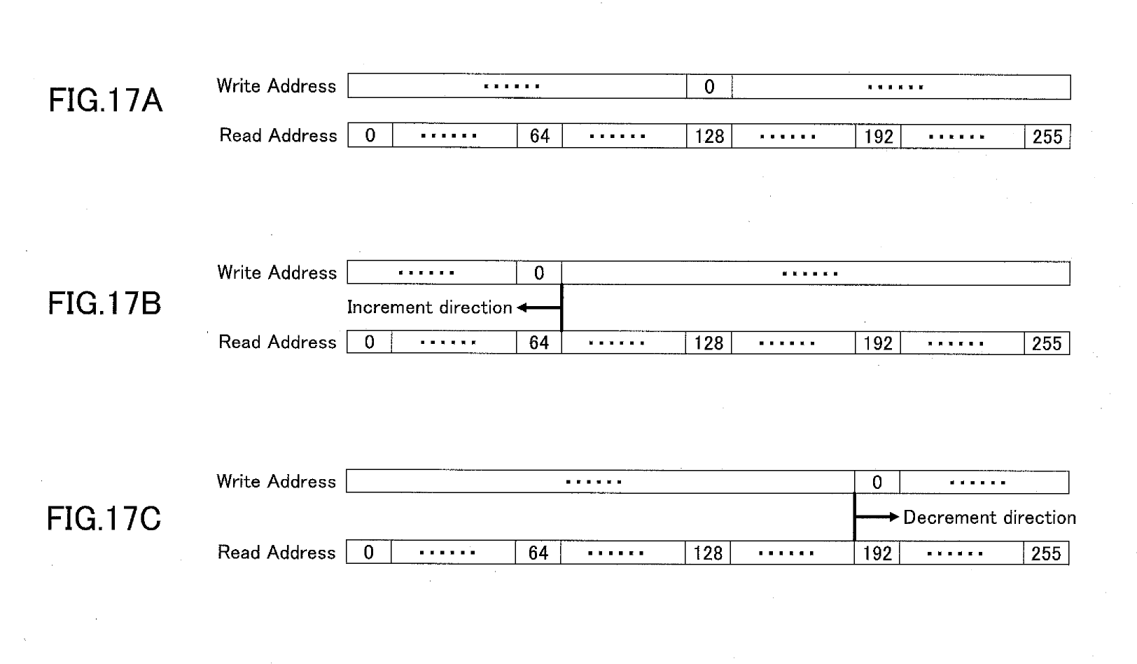

The memory monitoring circuit 141 functions as a Cn computing unit that generates the increment request and the decrement request by monitoring the write address and the read address. As illustrated in FIG. 17A, a state in which the write address is 0, the read address is 128, and the phase error is a maximum, is an ideal state for absorbing the frequency deviation of the client clock and the system clock in the memory 46.

For this reason, when the memory monitoring circuit 141 detects that the write address is 0 when the read address is 0 to 64 as illustrated in FIG. 17B, the memory monitoring circuit 141 generates the increment request for the C8 value by regarding that the system clock used as a read clock is faster than the client clock used as a write clock. Hence, when the C8 value becomes large and the number of stuff bytes becomes small, the read address extends and the read address when the write address is 0 becomes larger than 65.

On the other hand, when the memory monitoring circuit 141 detects that the write address is 0 when the read address is 192 to 255 as illustrated in FIG. 17C, the memory monitoring circuit 141 generates the decrement request for the C8 value by regarding that the system clock used as the read clock is slower than the client clock used as the write clock. Hence, when the C8 value becomes small and the number of stuff bytes becomes large, the read address extends for a shorter time compared to FIG. 17B and the read address when the write address is 0 becomes smaller than 192.

The C8 computing unit 154 includes an up-down counter 155 that increments the C8 value in response to the increment request from the memory monitoring circuit 141 and decrements the C8 value in response to the decrement request from the memory monitoring circuit 141. The C8 computing unit 154 further includes the stuff position table 55 and the register 56.

The C8 computing unit 154 refers to the stuff position table 55 (selects the column) using the C8 value sent in the previous frame and retained in the register 56 in order to obtain the stuff byte positions, and generates and supplies to the ODU0 mapping unit 52 the payload stuff byte enable signal that assumes the low-level at the stuff byte positions. In addition, the C8 computing unit 154 compares the C8 value of the up-down counter 155 and the C8 value sent in the previous frame. Based on this comparison of C8 values, the C8 computing unit 154 generates and supplies to the ODU0 mapping unit 52 a 14-bit C8 value (set to the C8 value of the up-down counter 155), the II and DI bits, and the stuff information indicating the 1-byte increase or the 2-byte increase from the previous frame, the 1-byte decrease or the 2-byte decrease from the previous frame, the new value (new), and the like to be set in the JC1 and JC2 bytes.

Further, the C8 computing unit 154 generates the payload enable after stuff signal that instructs the OPU0 payload part by the high level thereof and the stuff byte position by the low level thereof. This payload enable after stuff signal is supplied to the GFP-T frame mapping unit 40 and the ODU0 mapping unit 52.

<First Embodiment of C8 Computing Unit>

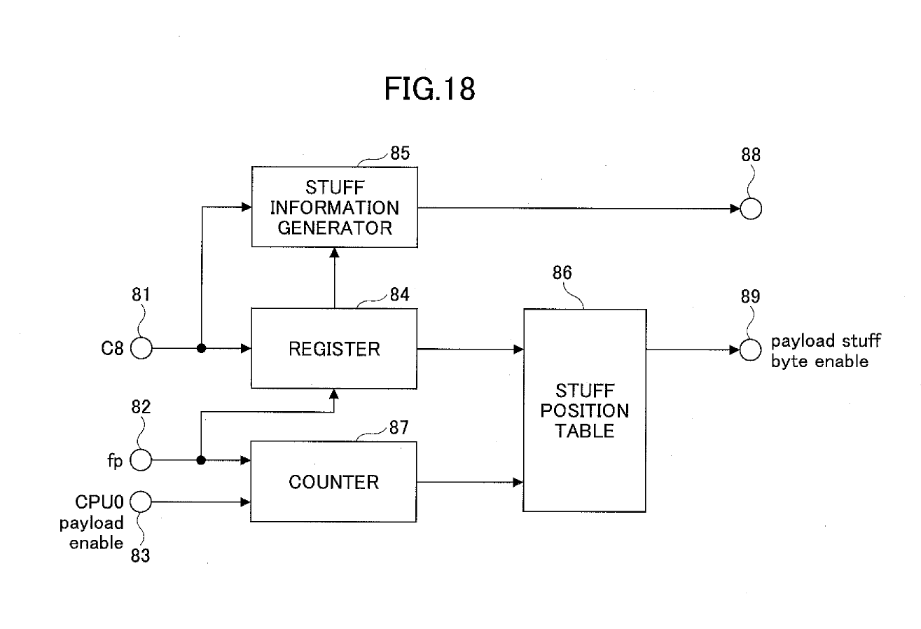

FIG. 18 is a block diagram illustrating an example of a structure of the C8 computing unit 54 in a first embodiment. In FIG. 18, the C8 value, the OPU0 frame start pulses fp, and the OPU0 payload enable signal are input to terminals 81, 82, and 83, respectively. The C8 value from the terminal 81 is retained in a register 84 (corresponding to the register 56 illustrated in FIG. 6) after a predetermined time from a rising edge of the OPU0 frame start pulse fp. The C8 value of the previous ODU0 frame retained in the register 84 is supplied to a stuff information generator 85 and a stuff position table 86 which may be the same as the stuff position table 55 illustrated in FIG. 8.

The OPU0 frame start pulses fps and the OPU0 payload enable signal from the terminals 82 and 83 are supplied to a counter 87. The counter 87 is reset in response to the rising edge of the OPU0 frame start pulse fp, and counts up in units of bytes with reference to the system clock on the higher layer frame side during the high-level period of the OPU0 payload enable signal. A counted value of the counter 87 is supplied to the stuff position table 86.

The stuff information generator 85 compares the C8 value from the terminal 81 and the C8 value of the previous frame retained in the register 84. Based on the comparison result, the stuff information generator 85 generates and outputs from a terminal 88 the 14-bit C8 value (C8 value to be set that is received from the C8 calculator 53) and the II and DI bits to be set in the JC1 and JC2 bytes, and the stuff information indicating the 1-byte increase or the 2-byte increase from the previous frame, the 1-byte decrease or the 2-byte decrease from the previous frame, the new value (new), and the like.

The stuff position information illustrated in FIG. 8 is registered in advance in the stuff position table 86. A reference is made to the stuff position table 86 using the C8 value from the register 84 in order to select the column, and the stuff byte position is found from the counted value of the counter 87. The payload stuff byte enable signal that assumes the low level at the stuff byte position is generated from the stuff position table 86 and output from a terminal 89.

<Second Embodiment of C8 Computing Unit>

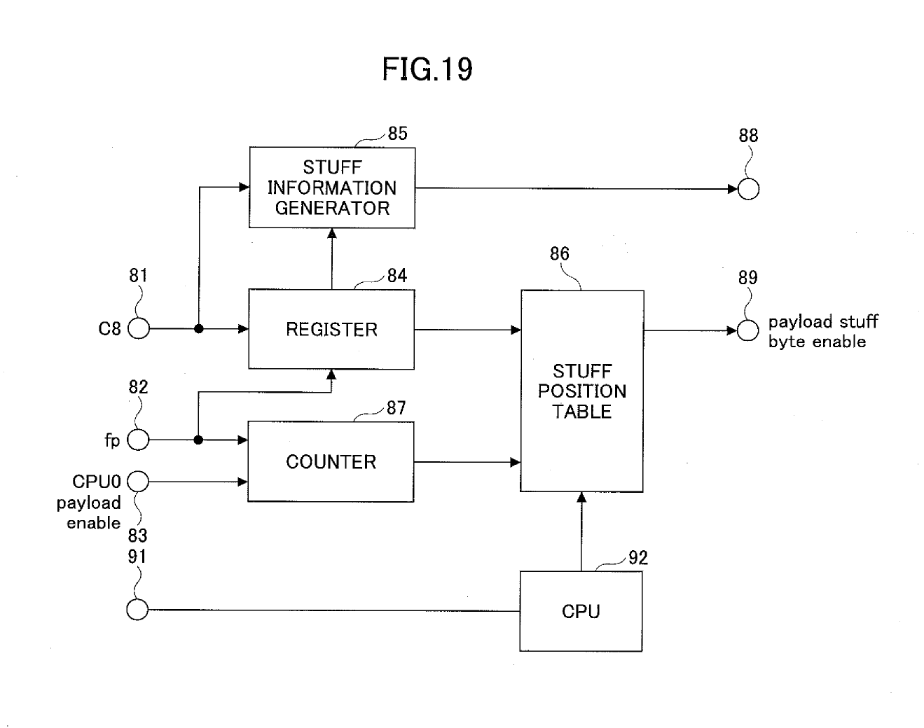

FIG. 19 is a block diagram illustrating an example of the structure of the C8 computing unit 54 in a second embodiment. In the first embodiment, the stuff position information is registered in advance in the stuff position table 86 illustrated in FIG. 8. On the other hand, in the second embodiment, a CPU (Central Processing Unit) 92 is provided, and this CPU 92 generates the stuff position information and registers the generated stuff position information in the stuff position table 86. The formula (2), or values “m” and “15232” in the formula (2) forming parameters, are supplied to the CPU 92 from a host unit (not illustrated) via a terminal 91. The CPU 92 computes the stuff position information illustrated in FIG. 8 by executing the computation of the formula (2), and registers the computed stuff position information in the stuff position table 86. The computation of the stuff position information need only be executed once before the actual start of the operation of the ODU mapper 34.

According to this embodiment, the client data may be mapped not only to the OPU0 payload area but also the payload area of systems other than the OPUk, by modifying the formula (2) or the values “m” and “15232” in the formula (2).

<Third Embodiment of C8 Computing Unit>

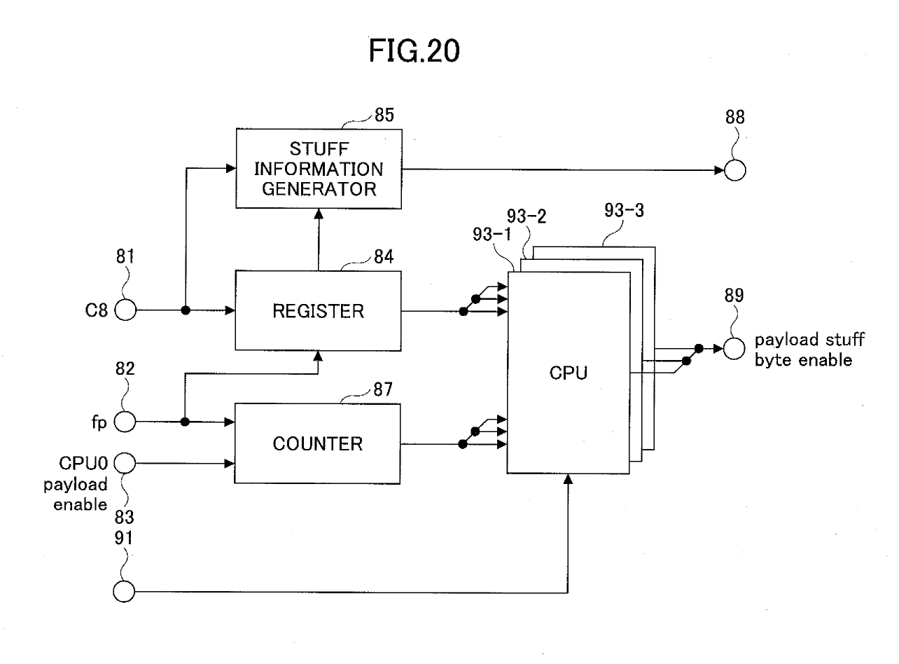

FIG. 20 is a block diagram illustrating an example of the structure of the C8 computing unit 54 in a third embodiment. In the first embodiment, the stuff position information is registered in advance in the stuff position table 86 illustrated in FIG. 8. On the other hand, in the third embodiment, CPUs 93-1, 93-2, and 93-3 are provided, and the stuff position information is generated by the CPUs 93-1, 93-2, and 93-3.

The formula (2), or values “m” and “15232” in the formula (2), are supplied to the CPUs 93-1, 93-2, and 93-3 from a host unit (not illustrated) via the terminal 91. The C8 value from the register 84 and the counted value of the counter 87 are also supplied to the CPUs 93-1, 93-2, and 93-3. Each of the CPUs 93-1, 93-2, and 93-3 computes the stuff position information illustrated in FIG. 8 by executing the computation of the formula (2), and generates and outputs the payload stuff byte enable signal that assumes the low level at the stuff byte position from the terminal 89.

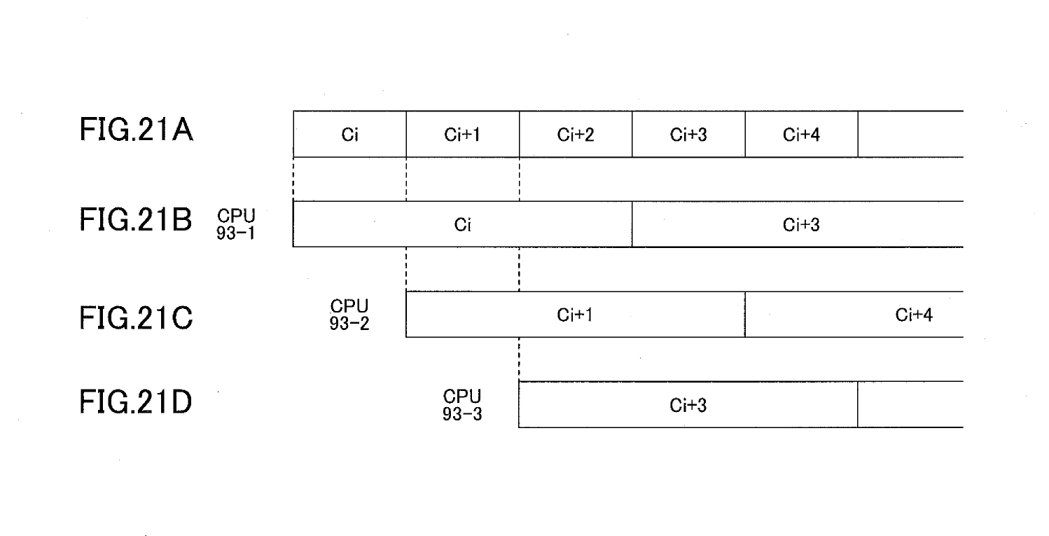

When the C8 values Ci, Ci+1, Ci+2, Ci+3, and Ci+4 illustrated in FIG. 21A are successively supplied from the register 84, the C8 values Ci and Ci+3 are supplied to the CPU 93-1, the C8 values Ci+1 is supplied to the CPU 93-2, and the C8 value Ci+2 is supplied to the CPU 93-3. The CPUs 93-1, 93-2, and 93-3 compute the stuff position information depending on the C8 values supplied thereto as illustrated in FIGS. 21B, 21C, and 21D, and generate the payload stuff byte enable signal.

In this third embodiment, the payload stuff byte enable signal may be generated in real-time by the distributed processing of the CPUs 93-1, 93-2, and 93-3. In addition, similarly to the second embodiment, this third embodiment may map the client data not only to the OPU0 payload area but also the payload area of systems other than the OPUk, by modifying the formula (2) or the values “m” and “15232” in the formula (2).

Although the embodiments are numbered with, for example, “first,” “second,” or “third,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus for an optical transport network, comprising:
a mapping unit configured to map client data to a payload of an optical transport unit in order to obtain a higher layer frame generated based on a clock on the optical transport network side; and
an interface unit configured to send the higher layer frame to the optical transport network,
wherein the mapping unit includes a Cn computing unit configured to compute a Cn value indicating an amount of the client data to be mapped to the payload of the optical transport unit, based on a counted value, counted using a clock of the client data, of a time period corresponding to the payload of the optical transport unit in the higher layer frame generated using a clock of the optical transport network, and
wherein information of the Cn value computed by the Cn computing unit is mapped to an overhead of the optical transport unit.

2. The transmission apparatus as claimed in claim 1, wherein the Cn computing unit computes the Cn value based on a counted value of a period of a start pulse indicating a start of the optical transport unit, using the clock of the client data.

3. The transmission apparatus as claimed in claim 1, wherein the Cn computing unit obtains the Cn value based on a monitored result of a read address and a write address of a memory for converting the client data synchronized to the clock of the client data into client data synchronized to the clock on the optical transport network side.

4. The transmission apparatus as claimed in claim 1, further comprising:
a position storage unit configured to store in advance stuff positions for mapping dummy data to the payload of the optical transport unit depending on the Cn value,
wherein the mapping unit maps the dummy data at the stuff positions obtained by referring to the position storage unit by the Cn value computed by the Cn computing unit, and maps the client data at positions other than the stuff positions of the dummy data.

5. The transmission apparatus as claimed in claim 4, wherein the position storage unit stores in advance the stuff positions that are obtained by the Sigma-Delta distribution method depending on the Cn value.

6. The transmission apparatus as claimed in claim 5, further comprising:
a Cn detector configured to detect the Cn value from information of the Cn value mapped in an overhead of the optical transport unit received from the optical transport network; and
a unit configured to obtain the stuff positions of the dummy data by referring to the position storage unit using the Cn value detected by the Cn detector, and to obtain the client data mapped at the positions other than the stuff positions of the dummy data.

7. The transmission apparatus as claimed in claim 4, further comprising:
a position computing unit configured to compute the stuff positions where the dummy data are to be mapped to the payload of the optical transport unit depending on the Cn value, according to a formula in response to the formula or parameters of the formula provided from a host unit, and to store the computed stuff positions in the position storage unit.

8. The transmission apparatus as claimed in claim 1, further comprising:
a plurality of position computing units configured to compute the stuff positions where the dummy data are to be mapped to the payload of the optical transport unit depending on the Cn value, according to a formula in response to the formula or parameters of the formula provided from a host unit, and to store the computed stuff positions in the position storage unit,
wherein the mapping unit maps the dummy data at the stuff positions computed by the plurality of position computing units, and maps the client data at positions other than the stuff positions of the dummy data.

9. A stuff control method to be implemented in a transmission apparatus for an optical transport network, comprising:
mapping client data to a payload of an optical transport unit in order to obtain a higher layer frame generated based on a clock on the optical transport network side;
sending the higher layer frame to the optical transport network; and
computing a Cn value indicating an amount of the client data to be mapped to the payload of the optical transport unit, based on a counted value, counted using a clock of the client data, of a time period corresponding to the payload of the optical transport unit in the higher layer frame generated using a clock of the optical transport network,
wherein information of the Cn value computed by the computing is mapped to an overhead of the optical transport unit.

10. The stuff control method as claimed in claim 9, further comprising:
storing in advance, in a position storage unit, stuff positions for mapping dummy data to the payload of the optical transport unit depending on the Cn value; and
mapping the dummy data at the stuff positions obtained by referring to the position storage unit by the Cn value computed by the computing, and mapping the client data at positions other than the stuff positions of the dummy data.

11. The stuff control method as claimed in claim 10, wherein storing stores in advance, in the position storage unit, the stuff positions that are obtained by the Sigma-Delta distribution method depending on the Cn value.

12. The stuff control method as claimed in claim 11, further comprising:
detecting the Cn value from information of the Cn value mapped in an overhead of the optical transport unit received from the optical transport network; and
obtaining the stuff positions of the dummy data by referring to the position storage unit using the Cn value detected by the detecting, and obtaining the client data mapped at the positions other than the stuff positions of the dummy data.
